(19) United States
(12) Patent Application Publication
(10) Pub. No.: US 2017/0155604 A1
(43) Pub. Date: Jun. 1, 2017

(54) METHOD AND DEVICE FOR PROCESSING INFORMATION

(71) Applicant: Xiaomi Inc., Beijing (CN)

(72) Inventors: Qian WANG, Beijing (CN); Yin ZHU, Beijing (CN)

(73) Assignee: Xiaomi Inc.

(21) Appl. No.: 15/233,113

(22) Filed: Aug. 10, 2016

(30) Foreign Application Priority Data
Dec. 1, 2015 (CN) 201510862737.9

(51) Int. Cl. H04L 12/58; H04L 29/12

(52) U.S. Cl. CPC H04L 51/046; H04L 51/36; H04L 61/1594

(57) ABSTRACT

The present disclosure relates to a method and a device for processing information. The method includes: receiving a message entered by a user in an information interface and recognizing a type of the message; based on the type of the message, calling an application to process contents of the message; receiving a processing result generated by the application in processing the contents of the message; and in addition to displaying the message in the information interface, displaying information related to the processing result in the information interface.

### CROSS-REFERENCE TO RELATED APPLICATIONS

This application is based upon and claims priority to Chinese Patent Application No. 201510862737.9, filed Dec. 1, 2015, the entire contents of which are incorporated herein by reference.

### TECHNICAL FIELD

The present disclosure generally relates to the field of computer technology and, more particularly, to a method and a device for processing information.

### BACKGROUND

The development of terminal technology has brought great convenience to people's everyday life. For example, a user can use different applications installed in a terminal to perform various operations, such as sending instant messages, doing calculations, making payments, transferring funds, and the like. Conventionally, when using multiple unrelated applications, the user needs to frequently switch between different applications to perform the respective functions.

### SUMMARY

According to a first aspect of the present disclosure, there is provided a method performed in a terminal for processing information, comprising: receiving a message entered by a user in an information interface and recognizing a type of the message; based on the type of the message, calling an application to process contents of the message; receiving a processing result generated by the application in processing the contents of the message; and in addition to displaying the message in the information interface, displaying information related to the processing result in the information interface.

According to a second aspect of the present disclosure, there is provided a device for processing information, comprising: a processor; and a memory storing instructions executable by the processor; wherein the processor is configured to perform: receiving a message entered by a user in an information interface and recognizing a type of the message; based on the type of the message, calling an application to process contents of the message; receiving a processing result generated by the application in processing the contents of the message; and in addition to displaying the message in the information interface, displaying information related to the processing result in the information interface.

According to a third aspect of the present disclosure, there is provided a non-transitory computer-readable storage medium storing instructions that, when executed by one or more processors of a device, cause the device to perform a method for processing information, the method comprising: receiving a message entered by a user in an information interface and recognizing a type of the message; based on the type of the message, calling an application to process contents of the message; receiving a processing result generated by the application in processing the contents of the message; and in addition to displaying the message in the information interface, displaying information related to the processing result in the information interface.

It is to be understood that both the foregoing general description and the following detailed description are exemplary and explanatory only and are not restrictive of the present invention, as claimed.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a flowchart of a method for processing information, according to an exemplary embodiment.

FIG. 2 is a flowchart of a method for processing information, according to an exemplary embodiment.

FIG. 3 is a block diagram of a device for processing information, according to an exemplary embodiment.

FIG. 4 is a block diagram of a device for processing information, according to an exemplary embodiment.

FIG. 5 is a block diagram of an information display module, according to an exemplary embodiment.

FIG. 6 is a block diagram of an information display module, according to an exemplary embodiment.

FIG. 7 is a block diagram of a device for processing information, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present disclosure. Instead, they are merely examples of devices and methods consistent with aspects related to the invention as recited in the appended claims.

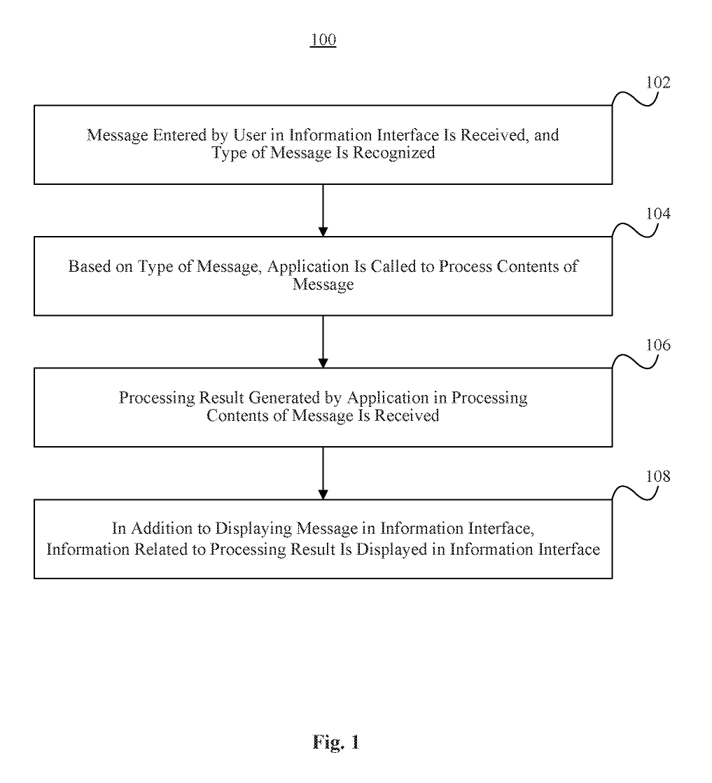

FIG. 1 is a flowchart of a method 100 for processing information, according to an exemplary embodiment. For example, the method 100 is performed in a terminal, such as a mobile phone, a tablet computer, or a smart TV. As shown in FIG. 1, the method 100 includes the following steps.

In step 102, a message entered by a user in an information interface is received and a type of the message is recognized.

In step 104, based on the type of the message, an application is called to process contents of the message.

In step 106, a processing result generated by the application in processing the contents of the message is received.

In step 108, in addition to displaying the message in the information interface, information related to the processing result is displayed in the information interface.

After a message is entered in an information interface, the method 100 calls an application corresponding to the type of the message, and uses the application to process the message. The method 100 further displays information related to a processing result generated by the application in processing the message. This way, a user can call an application in the information interface.

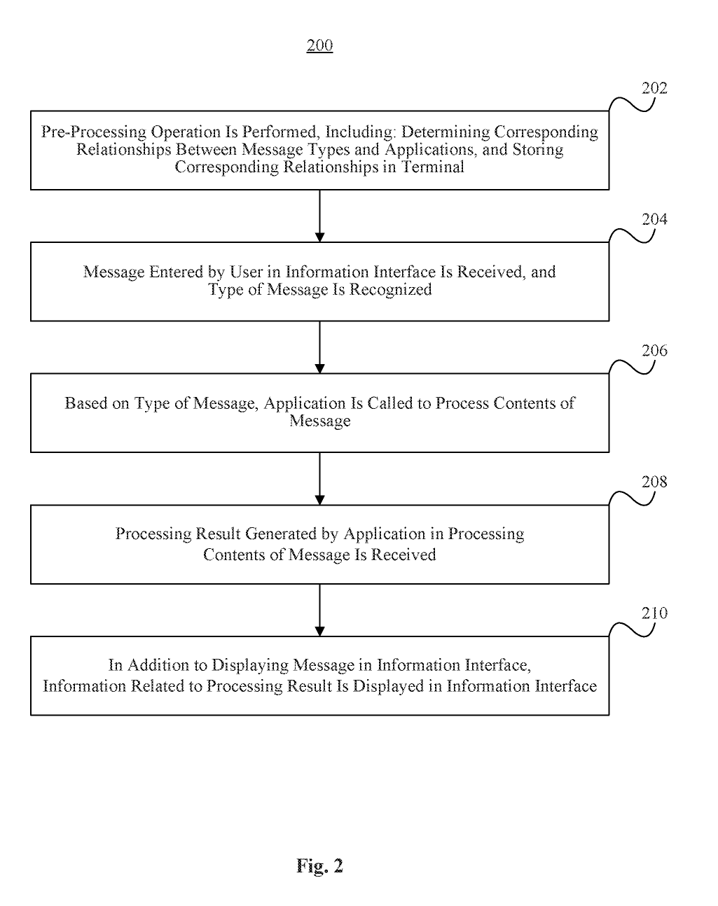

FIG. 2 is a flowchart of a method 200 for processing information, according to an exemplary embodiment. For example, the method 200 is performed in a terminal, such as a mobile phone, a tablet computer, or a smart TV. As shown in FIG. 2, the method 200 includes the following steps.

In step 202, a pre-processing operation is performed, including: determining corresponding relationships between message types and applications, and storing the corresponding relationships in the terminal.

Exemplary corresponding relationships between message types and applications include: communication information corresponding to an application for storing and managing a contact list (hereinafter referred to as “contact list”), calculation formulas corresponding to an application for performing calculations (hereinafter referred to as “calculator”), numbers corresponding to an application for making payments (hereinafter referred to as “payment application”), words corresponding to an operating system of the terminal (herein after referred to as “terminal system”), and sentences corresponding to a predetermined application (e.g., map, gallery, and the like). “Sentence” used in this disclosure includes at least a predicate and an object. “Word” used in this disclosure is constituted of morphemes, and is the smallest language unit (other than communication information or a number) that can be independently used.

In step 204, a message entered by a user in an information interface is received and a type of the message is recognized.

For example, the information interface may be a short message service (SMS) input/output interface. The terminal recognizes the type of the message as communication information (including a person's legal name, nickname, and the like), a number, a calculation formula, a sentence, or a word.

In step 206, based on the type of the message, an application is called to process the contents of the message.

Depending on the type of the entered message, step 206 may be performed according to the following situations.

In a first situation, step 206 includes: when the entered message is recognized as communication information, calling a contact list of the terminal and sending the communication information to the contact list that is queried to determine whether the communication information matches a pre-stored entry in the contact list. For example, the contact list may include a phonebook of the terminal and/or a contact list used by an instant messaging (IM) application.

In a second situation, step 206 includes: when the entered message is recognized as a calculation formula, calling a calculator of the terminal and sending the calculation formula to the calculator to calculate the calculation formula through the calculator.

In a third situation, step 206 includes: when the entered message is recognized as a number, calling a payment application of the terminal and sending the number to the payment application to process the number through the payment application.

In a fourth situation, step 206 includes: when the entered message is recognized as a word, calling a terminal system (i.e., the operating system of the terminal) and sending the word to the terminal system to determine, through the terminal system, whether an application installed in the terminal matches the word.

In a fifth situation, step 206 includes: when the entered message is recognized as a sentence, calling a predetermined application installed in the terminal and sending the sentence to the predetermined application to process the sentence through the predetermined application.

In step 208, a processing result generated by the application in processing the message is received.

In step 210, in addition to displaying the message in the information interface, information related to the processing result is displayed in the information interface.

Corresponding to the five situations described in step 206, step 210 is also implemented according to five different situations.

In a first situation, the entered message is recognized as communication information. In one embodiment, step 210 includes: when it is determined that the communication information matches one or more entries in the contact list, sequentially displaying the one or more entries.

In another embodiment, step 210 includes: when it is determined that the communication information matches one or more entries in the contact list, displaying an identifier of the contact list that contains at least one of the one or more entries. For example, if the communication information matches any entry in the phonebook of the terminal, displaying an identifier of the phonebook of the terminal, and/or if the communication information matches any entry in the contact list used by an IM application, displaying an identifier of the contact list used by the IM application.

In yet another embodiment, step 210 includes: when it is determined that the communication information matches one or more entries in the contact list, marking up the communication information in the information interface.

For example, when a user enters a person's name in the information interface of the terminal, a local phonebook and a contact list used by an IM application are called. The phonebook and the contact list of the IM application are queried to determine whether an entries therein match the person's name In one embodiment, if the phonebook and/or the contact list of the IM software contains the person's name and other related contact information, such as a phone number, an address, a mail box, or an account associated with the IM application and the like, the related contact information is displayed as a recommended result in a suggestion box of the information interface, such that the user can select and/or make other uses of the related contact information. In another embodiment, if the phonebook or the contact list of the IM application contains the person's name and other related contact information, an identifier of the phonebook or an identifier of the contact list used by the IM application is displayed as a recommended result in the suggestion box of the information interface, such that the user can click and open the phonebook or the IM application in the information interface. This way, the user can contact a person or look up information regarding the person without having to return to the desktop to find and open the phonebook or the IM application. In yet another embodiment, if the phonebook and/or the contact list of the IM application contains the person's name and other related contact information, the person's name is marked up in the information interface, to inform the user that the person's name is present in the phonebook or the contact list of the IM application.

In a second situation, the entered message is recognized as a calculation formula. In one embodiment, step 210 includes: displaying the calculation result after the calculation formula.

In another embodiment, step 210 includes: displaying an identifier of the calculator or the calculation result in a suggestion box of the information interface.

For example, when the user enters a calculation formula in the information interface, a calculator is called to calculate the calculation formula. Then the calculation result is directly displayed after the calculation formula. Alternatively, the calculation result or the identifier of the calculator is displayed as a recommended result in a suggestion box of the information interface, such that the user can obtain the result and/or select the result for further use.

In a third situation, the entered message is recognized as a number. Step 210 includes: displaying an identifier of the payment application or prompting the user whether to transfer funds in an amount equal to the number.

For example, when a user enters a number in the information interface, a pre-installed payment application is called to process the number, e.g., to deduct the equivalent amount of money from the user's account, and/or prompt the user whether to transfer this money to another party. This way, the user can complete the payment in the information interface, such as an SMS input/output interface, without entering the payment application's user interface. Alternatively, an identifier of the payment application is displayed as a recommended application in a suggestion box of the information interface. This way, the user can directly select the payment application from the information interface, avoiding the extra steps of going to a desktop to select the payment application.

In a fourth situation, the entered message is recognized as a word. Step 210 includes: displaying an identifier of an application associated with the word.

For example, when the user enters a word in the information interface, it is determined, by the terminal system, whether the word is associated with the name of an application that has been downloaded and/or installed in the terminal. If an associated application is found, an identifier of the associated application is displayed in a suggestion box of the information interface, such that the user can select and use the application.

In a fifth situation, the entered message is recognized as a sentence. Step 210 includes: displaying an identifier of the predetermined application, or displaying the processing result generated by the predetermined application in processing the sentence.

For example, when a user enters a sentence, e.g., “I am beside the fountain in X X Square,” in the information interface, a predetermined application (e.g., an electronic map) is called to search for the location of “the fountain in X X Square,” and the found address is displayed in the information interface, such that the user can select and use the address. This way, the user can quickly know other information relevant to a sentence that is currently inputted or edited in the information interface.

The following embodiments are devices that may be used to perform the above-described methods. Any undisclosed details of the devices may be found by referring to the above-described methods.

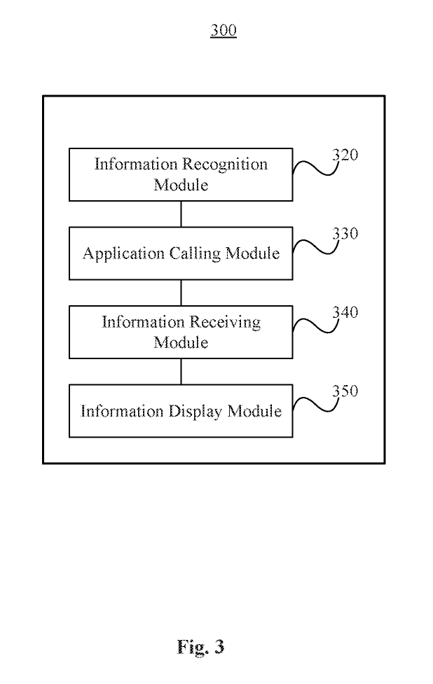

FIG. 3 is a block diagram of a device 300 for processing information, according to an exemplary embodiment. For example, the device 300 is implemented as a part or whole of a terminal by software, or hardware, or a combination of software and hardware. The terminal may be a mobile phone, a tablet computer, or a smart TV. Referring to FIG. 3, the device 300 includes an information recognition module 320, an application calling module 330, an information receiving module 340, and an information display module 350.

The information recognition module 320 is configured to receive a message entered by a user in an information interface, and recognize the type of the message.

The application calling module 330 is configured to, based on the type of the message, call an application to process the contents of the message.

The information receiving module 340 is configured to receive a processing result generated by the application in processing the contents of the message.

The information display module 350 is configured to, in addition to displaying the message, display information related to the processing result in the information interface.

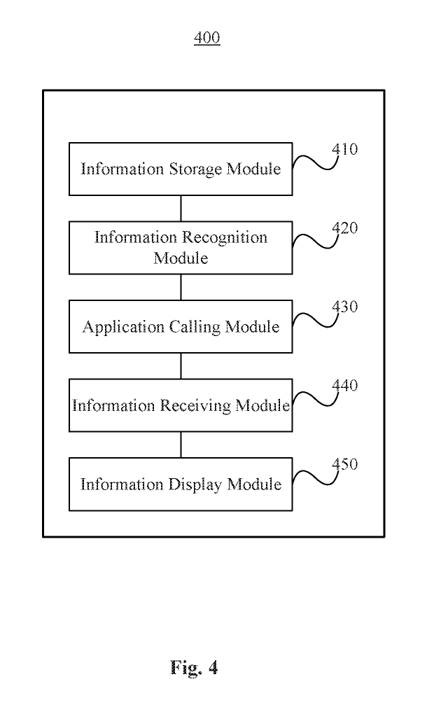

FIG. 4 is a block diagram of a device 400 for processing information, according to an exemplary embodiment. For example, the device 400 is implemented as a part or whole of a terminal by software, or hardware, or a combination of software and hardware. The terminal may be a mobile phone, a tablet computer, or a smart TV. Referring to FIG. 4, the device 400 includes an information storage module 410, an information recognition module 420, an application calling module 430, an information receiving module 440, and an information display module 450.

The information storage module 410 is configured to determine and store corresponding relationships between message types and applications.

The information recognition module 420, the application calling module 430, the information receiving module 440, and the information display module 450 are similar to the information recognition module 320, the application calling module 330, the information receiving module 340, and the information display module 350, respectively (FIG. 3).

In some embodiments, the application calling module 430 is further configured to: when the information recognition module 420 recognizes the message entered by the user as communication information, call a contact list in the terminal and send the communication information to the contact list that is queried to determine whether one or more entries in the contact list match the communication information. The contact list may include a phonebook locally stored in the terminal and/or a contact list in an IM application.

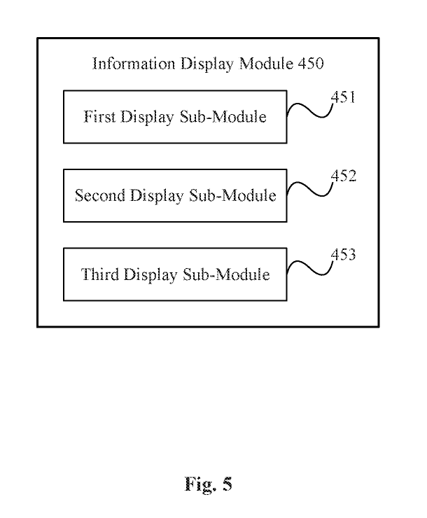

FIG. 5 is a block diagram of an information display module 450, according to an exemplary embodiment. Referring to FIG. 5, the information display module 450 further includes a first display sub-module 451, a second display sub-module 452, and/or a third display sub-module 453, some or all of which are used when the information recognition module 420 recognizes the message entered by the user as communication information.

The first display sub-module 451 is configured to, in addition to displaying the entered communication information in the information interface, sequentially display the entries in the contact list that are determined matching the communication information.

The second display sub-module 452 is configured to, in addition to displaying the entered communication information in the information interface, display an identifier of the contact list that is determined containing entries that match the entered communication information.

The third display sub-module 453 is configured to, in addition to displaying the entered communication information entered in the information interface, mark up the communication information that is determined matching one or more entry in the contact list in the information interface.

In some embodiments, the application calling module 430 is further configured to: when the information recognition module 420 recognizes the message entered by the user as a calculation formula, call a calculator in the terminal and send the calculation formula to the calculator to calculate the calculation formula through the calculator.

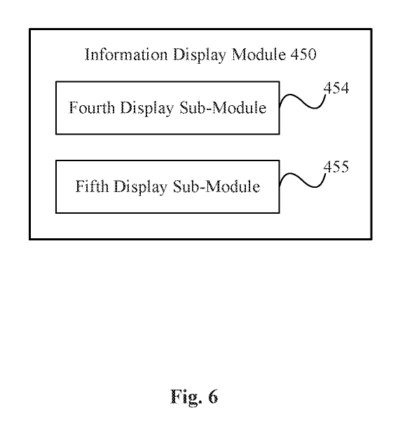

FIG. 6 is a block diagram of an information display module 450, according to an exemplary embodiment. Referring to FIG. 6, the information display module 450 further includes a fourth display sub-module 454 and/or a fifth display sub-module 455, one or both of which are used when the information recognition module 420 recognizes the message entered by the user as a calculation formula.

The fourth display sub-module 454 is configured to, in addition to displaying the entered calculation formula in the information interface, display the calculation result after the calculation formula.

The fifth display sub-module 455 is configured to, in addition to displaying the entered calculation formula in the information interface, display an identifier of the calculator or the calculation result in a suggestion area of the information interface.

In some embodiments, the application calling module 430 is further configured to: when the information recognition module 420 recognizes the message entered by the user as a number, call a payment application in the terminal and send the number to the payment application to process the number through the payment application.

Correspondingly, the information display module 450 is further configured to: when the information recognition module 420 recognizes the message entered by the user as a number, display an identifier of the payment application or prompt the user whether to transfer funds with an amount equal to the number.

In some embodiments, the application calling module 430 is further configured to: when the information recognition module 420 recognizes the message entered by the user as a word, call the terminal system and send the word to the terminal system to determine whether the word is associated with an application installed in the terminal through the terminal system.

Correspondingly, the information display module 450 is further configured to: when the information recognition module 420 recognizes the message entered by the user as a word, display an identifier of the application that is determined to be associated with the word.

In some embodiments, the application calling module 430 is further configured to: when the information recognition module 420 recognizes the message entered by the user as a sentence, call a predetermined application installed in the terminal and send the sentence to the predetermined application to process the sentence through the predetermined application.

Correspondingly, the information display module 450 is further configured to: when the information recognition module 420 recognizes the message entered by the user as a sentence, display an identifier of the predetermined application, or display a processing result generated by the predetermined application in processing the sentence.

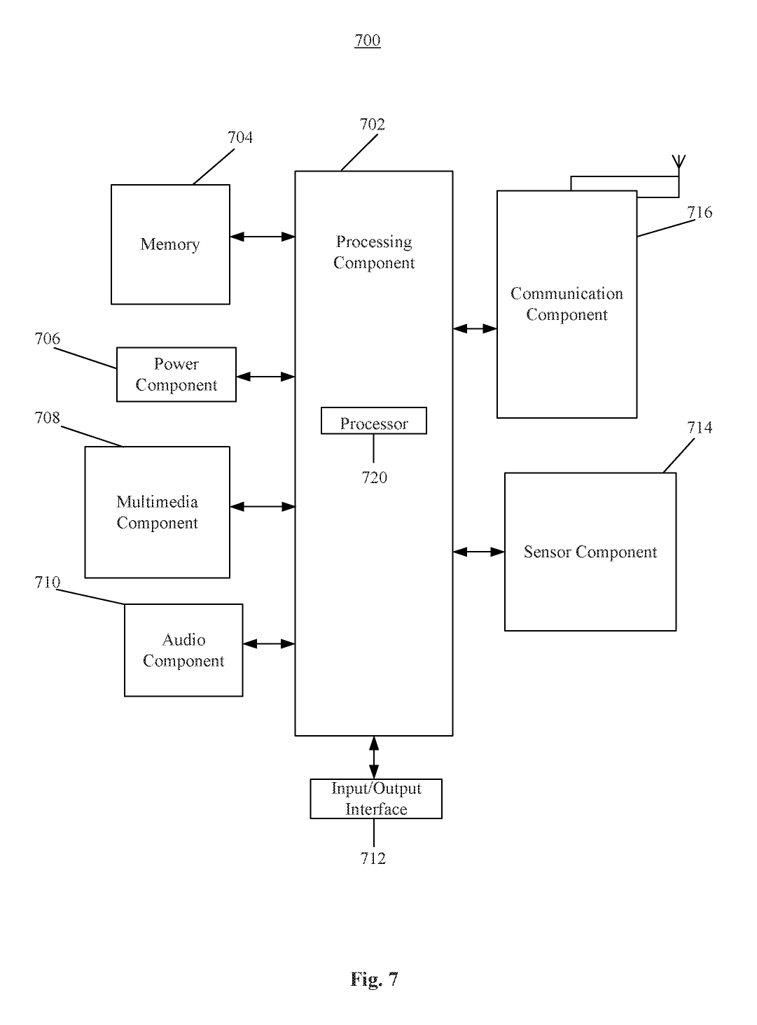

FIG. 7 is a block diagram of a device 700 for processing information, according to an exemplary embodiment. For example, the device 700 may be a terminal, such as a mobile phone, a tablet computer, a smart TV, or the like.

Referring to FIG. 7, the device 700 may include one or more of the following components: a processing component 702, a memory 704, a power component 706, a multimedia component 708, an audio component 710, an input/output (110) interface 712, a sensor component 714, and a communication component 716.

The processing component 702 typically controls overall operations of the device 700, such as the operations associated with display, telephone calls, data communications, camera operations, and recording operations. The processing component 702 may include one or more processors 720 to execute instructions to perform all or part of the steps in the above described methods. Moreover, the processing component 702 may include one or more modules which facilitate the interaction between the processing component 702 and other components. For instance, the processing component 702 may include a multimedia module to facilitate the interaction between the multimedia component 708 and the processing component 702.

The memory 704 is configured to store various types of data to support the operation of the device 700. Examples of such data include instructions for any applications or methods operated on the device 700, contact data, phonebook data, messages, pictures, video, etc. The memory 704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 706 provides power to various components of the device 700. The power component 706 may include a power management system, one or more power sources, and any other components associated with the generation, management, and distribution of power in the device 700.

The multimedia component 708 includes a screen providing an output interface between the device 700 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 708 includes a front camera and/or a rear camera. The front camera and/or the rear camera may receive external multimedia data while the device 700 is in an operation mode, such as a photographing mode or a video mode. Each of the front camera and the rear camera may be a fixed optical lens system or have focus and optical zoom capability.

The audio component 710 is configured to output and/or input audio signals. For example, the audio component 710 includes a microphone configured to receive an external audio signal when the device 700 is in an operation mode, such as a call mode, a recording mode, and a voice recognition mode. The received audio signal may be further stored in the memory 704 or transmitted via the communication component 716. In some embodiments, the audio component 710 further includes a speaker to output audio signals.

The I/O interface 712 provides an interface between the processing component 702 and peripheral interface modules, such as a keyboard, a click wheel, buttons, and the like. The buttons may include, but are not limited to, a home button, a volume button, a starting button, and a locking button.

The sensor component 714 includes one or more sensors to provide status assessments of various aspects of the device 700. For instance, the sensor component 714 may detect an open/closed status of the device 700, relative positioning of components, e.g., the display and the keypad, of the device 700, a change in position of the device 700 or a component of the device 700, a presence or absence of user contact with the device 700, an orientation or an acceleration/deceleration of the device 700, and a change in temperature of the device 700. The sensor component 714 may include a proximity sensor configured to detect the presence of nearby objects without any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate communication, wired or wirelessly, between the device 700 and other devices. The device 700 can access a wireless network based on a communication standard, such as WiFi, 2G, 3G, 4G, or a combination thereof. In one exemplary embodiment, the communication component 716 receives a broadcast signal or broadcast associated information from an external broadcast management system via a broadcast channel In one exemplary embodiment, the communication component 716 further includes a near field communication (NFC) module to facilitate short-range communications. For example, the NFC module may be implemented based on a radio frequency identifier (RFID) technology, an infrared data association (IrDA) technology, an ultra-wideband (UWB) technology, a Bluetooth (BT) technology, and other technologies.

In exemplary embodiments, the device 700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods for processing information.

In exemplary embodiments, there is also provided a non-transitory computer-readable storage medium including instructions, such as included in the memory 704, executable by the processor 720 in the device 700, for performing the above-described methods for processing information. For example, the non-transitory computer-readable storage medium may be a ROM, a RAM, a CD-ROM, a magnetic tape, a floppy disc, an optical data storage device, and the like.

Although features and elements are described above in particular combinations, one of ordinary skill in the art will appreciate that each feature or element may be used alone, or in any combination with the other feature and elements if no contradiction exists. Other embodiments of the present disclosure will be apparent to those skilled in the art from consideration of the specification and practice of the present disclosure disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claim.

It will be appreciated that the present disclosure is not limited to the exact construction that has been described above and illustrated in the accompanying drawings, and that various modifications and changes can be made without departing from the scope thereof. It is intended that the scope of the present disclosure only be limited by the appended claims.

What is claimed is:

1. A method performed in a terminal for processing information, comprising:
receiving a message entered by a user in an information interface and recognizing a type of the message;
based on the type of the message, calling an application to process contents of the message;
receiving a processing result generated by the application in processing the contents of the message; and
in addition to displaying the message in the information interface, displaying information related to the processing result in the information interface.

2. The method according to claim 1, further comprising:
determining corresponding relationships between message types and applications, and storing the corresponding relationships in the terminal.

3. The method according to claim 1, wherein, based on the type of the message, the calling of the application to process the contents of the message comprises:
when the message is recognized as communication information, calling a contact list in the terminal and sending the communication information to the contact list that is queried to determine whether the communication information matches one or more entries in the contact list, the contact list including at least one of a phonebook of the terminal or a contact list used by an instant messaging application.

4. The method according to claim 3, wherein, in response to the determination that the communication information matches one or more entries in the contact list, the displaying of the information related to the processing result in the information interface includes at least one of:
sequentially displaying the one or more entries that match the communication information;
displaying an identifier of the contact list that contains at least one of the one or more entries that match the communication information; or
marking up, in the information interface, the communication information that is determined matching the one or more entries.

5. The method according to claim 1, wherein, based on the type of the message, the calling of the application to process the contents of the message comprises:
when the message is recognized as a calculation formula, calling a calculator in the terminal and sending the calculation formula to the calculator to calculate the calculation formula through the calculator.

6. The method according to claim 5, wherein the displaying of the information related to the processing result in the information interface includes at least one of:
displaying a calculation result after the calculation formula; or
displaying an identifier of the calculator or the calculation result in a suggestion area of the information interface.

7. The method according to claim 1, wherein, based on the type of the message, the calling of the application to process the contents of the message comprises:
when the message is recognized as a number, calling a payment application in the terminal and sending the number to the payment application to process the number through the payment application.

8. The method according to claim 7, wherein the displaying of the information related to the processing result in the information interface includes at least one of:
displaying an identifier of the payment application; or
prompting the user whether to transfer funds with an amount equal to the number.

9. The method according to claim 1, wherein, based on the type of the message, the calling of the application to process the contents of the message comprises:
when the message is recognized as a word, calling an operating system of the terminal and sending the word to the operating system to determine, through the operating system, whether the terminal includes an application that is associated with the word.

10. The method according to claim 9, wherein the displaying of the information related to the processing result in the information interface comprises:
displaying an identifier of the application associated with the word.

11. The method according to claim 1, wherein, based on the type of the message, the calling of the application to process the contents of the message comprises:
when the message is recognized as a sentence, calling a predetermined application and sending the sentence to the predetermined application to process the sentence through the predetermined application.

12. The method according to claim 11, wherein the displaying of the information related to the processing result in the information interface includes at least one of:
displaying an identifier of the predetermined application; or
displaying the processing result generated by the predetermined application in processing the sentence.

13. A device for processing information, comprising:
a processor; and
a memory storing instructions executable by the processor;
wherein the processor is configured to perform:
receiving a message entered by a user in an information interface and recognizing a type of the message;
based on the type of the message, calling an application to process contents of the message;
receiving a processing result generated by the application in processing the contents of the message; and
in addition to displaying the message in the information interface, displaying information related to the processing result in the information interface.

14. The device according to claim 13, wherein the processor is further configured to perform:
determining corresponding relationships between message types and applications, and storing the corresponding relationships in the terminal.

15. The device according to claim 13, wherein the processor is further configured to perform:
when the message is recognized as communication information, calling a contact list in the terminal and sending the communication information to the contact list that is queried to determine whether the communication information matches one or more entries in the contact list, the contact list including at least one of a phonebook of the terminal or a contact list used by an instant messaging application.

16. The device according to claim 13, wherein the processor is further configured to perform:
when the message is recognized as a calculation formula, calling a calculator in the terminal and sending the calculation formula to the calculator to calculate the calculation formula through the calculator.

17. The device according to claim 13, wherein the processor is further configured to perform:
when the message is recognized as a number, calling a payment application in the terminal and sending the number to the payment application to process the number through the payment application.

18. The device according to claim 13, wherein the processor is further configured to perform:
when the message is recognized as a word, calling an operating system of the terminal and sending the word to the operating system to determined, through the operating system, whether the terminal includes an application that is associated with the word.

19. The device according to claim 13, wherein the processor is further configured to perform:
when the message is recognized as a sentence, calling a predetermined application and sending the sentence to the predetermined application to process the sentence through the predetermined application.

20. A non-transitory computer-readable storage medium storing instructions that, when executed by one or more processors of a device, cause the device to perform a method for processing information, the method comprising:
receiving a message entered by a user in an information interface and recognizing a type of the message;
based on the type of the message, calling an application to process contents of the message;
receiving a processing result generated by the application in processing the contents of the message; and
in addition to displaying the message in the information interface, displaying information related to the processing result in the information interface.
